(19) United States
(12) Patent Application Publication
(10) Pub. No.: US 2026/0219795 A1
(43) Pub. Date: Jul. 30, 2026

(54) METHODS AND APPARATUS FOR SAMPLED BANK REFRESH MANAGEMENT

(71) Applicant: Intel Corporation, Santa Clara, CA (US)

(72) Inventors: Zion Siu-On KWOK, Burnaby (CA); Saravanan SETHURAMAN, Portland, OR (US); Lucian COJOCAR, Bellevue, WA (US); Hussein ALAMEER, Hillsboro, OR (US)

(21) Appl. No.: 19/630,537

(22) Filed: Mar. 27, 2026

(51) Int. Cl. G06F 3/06

(52) U.S. Cl. CPC G06F 3/0632; G06F 3/0604; G06F 3/0673

(57) ABSTRACT

An apparatus includes: an interface coupled to a memory device comprising a plurality of memory banks, each memory bank comprising a plurality of memory rows; and control circuitry coupled to the interface, wherein the control circuitry is configured to: detect an activation command directed to a memory bank of the plurality of memory banks; determine, based on a sampling criterion, a result representing whether to issue a refresh management command in response to the detected activation command; and issue, based on the result, the refresh management command directed to the memory bank via the interface.

### BACKGROUND

Modern memory systems face reliability challenges arising from increasing device density and reduced feature sizes. As memory cells are scaled to smaller dimensions, the physical proximity between adjacent memory rows increases the susceptibility of stored data to disturbance effects. For example, repeated access to a memory row can cause charge leakage or other disturbance phenomena in physically neighboring memory rows, potentially resulting in data corruption.

To address such disturbance effects, memory systems can employ various mitigation techniques, including refresh-based approaches in which memory rows that are potentially affected by disturbance are refreshed to restore their stored charge. The timing and targeting of such refresh operations may be factors in maintaining data integrity while minimizing performance overhead. A memory controller that manages access to the memory device can participate in triggering these refresh operations, either reactively in response to signals from the memory device or proactively based on observed access patterns.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 illustrates a block diagram of an example memory system;

FIG. 3 illustrates a schematic diagram of an example apparatus in accordance with various aspects described herein;

FIG. 4 illustrates an example flow in accordance with various aspects described herein;

FIG. 5 shows an example of a method.

### DESCRIPTION

The present disclosure relates to memory controllers and memory systems, and in particular to apparatus and methods for managing refresh operations in memory devices. More specifically, the present disclosure relates to techniques by which a memory controller determines when to issue refresh management commands to a memory device in response to detected memory access patterns.

A memory controller may issue commands to a memory device to trigger mitigation operations. These operations may include refresh operations directed at memory rows that may have been disturbed by repeated access to neighboring rows. The manner in which the memory controller decides when to issue such commands, and the information that the memory controller includes in those commands, affects both the performance of the memory system and the effectiveness of the mitigation. Existing approaches involve trade-offs between the amount of hardware resources required in the memory controller, such as counters or tracking structures dedicated to monitoring access patterns, and the frequency of device-initiated interrupts that stall normal memory traffic. An approach that requires the memory controller to maintain detailed per-bank access counts imposes hardware overhead that scales with the number of memory banks in the system. Further, an approach that relies entirely on the memory device to signal when mitigation is needed can result in frequent interrupts under heavy access patterns, each interrupt imposing a latency penalty on normal memory operations. Techniques that allow the memory controller to proactively trigger mitigation operations while reducing both controller-side hardware overhead and the frequency of device-initiated interrupts may be desirable.

A dynamic random-access memory (DRAM) system includes one or more memory devices organized into a hierarchical structure of ranks, subchannels, banks, and rows. A memory controller, which may be integrated within a processor die or system-on-chip (SoC) or implemented as a discrete component, communicates with one or more memory devices over a command/address bus and a data bus. The memory controller can issue activation commands to open a specific memory row within a specified memory bank, enabling subsequent read or write operations on that row. After access is complete, the memory controller may issue a precharge command to close the open row. Each memory bank can have at most one memory row open at a time, and different memory banks operate independently, enabling activation commands directed to different banks to be interleaved in the command stream. In a system with multiple ranks and subchannels, the memory controller manages activation commands across all of these organizational units, and the total number of memory banks across ranks and subchannels may be large.

Repeated activation of a memory row, which can be referred to as an aggressor row, can induce charge leakage in physically adjacent memory rows, which can be referred to as victim rows, through a phenomenon known as Rowhammer. Sufficient charge leakage in a victim row can cause bit flips in that row, representing both a data integrity risk and a security vulnerability. The severity of the Rowhammer vulnerability increases as DRAM process technology scales to smaller feature sizes, because reduced cell dimensions decrease the charge isolation between adjacent rows. The Rowhammer threshold, commonly designated N_{RH}, may refer to the number of activations to an aggressor row within a refresh interval after which bit flips in adjacent victim rows become probable. As process technology advances, N_{RH} decreases, requiring more frequent and more precise mitigation to maintain data integrity. Mitigation may be needed at both the memory device level, where the device may maintain internal tracking structures, and at the memory controller level, where the controller may proactively issue commands to trigger device-side mitigation operations.

Various mitigation techniques involves refreshing the victim rows adjacent to a suspected aggressor row in order to restore their stored charge before bit flips occur. The memory controller can trigger such mitigation by issuing a refresh management command to the memory device, which causes the memory device to perform a targeted refresh operation for one or more rows within a specified memory bank. Different approaches exist for determining when and for which memory bank the memory controller should issue such refresh management commands. These approaches can differ in the information they require the memory controller to track, the information included in the refresh management command itself, and whether row address selection for the mitigation operation is performed by the memory controller or delegated to the memory device. The choice of approach affects controller hardware complexity, mitigation effectiveness, and memory system performance.

A memory controller may refer to a circuit configured to manage read and write operations to one or more memory devices. The memory controller may issue commands that direct memory devices to perform storage and retrieval operations, control the timing of data transfers, and process data received from memory devices during read operations. A memory device may be an integrated circuit including an array of storage cells that are accessible via a data interface. Memory devices retain data in addressable storage locations and transfer data to and from a memory controller in response to commands received over a command and address bus. A memory controller and one or more memory devices may communicate over a channel, which includes a set of signal connections, which may include data lines, strobe lines, clock lines, command and address lines, and chip select lines, through which the memory controller and the memory devices exchange data, commands, and timing signals. A memory subsystem may include one or more channels, each channel supporting one or more memory devices.

An activation command, as described herein, may refer to a command issued by a memory controller to a memory device that causes a specified memory row within a specified memory bank to be opened, or activated, for subsequent read or write operations. Upon receipt of an activation command, the memory device may apply selection voltages to the word line corresponding to the specified memory row, connecting the memory cells of that row to the sense amplifiers of the bank via the bit lines. The memory controller may track which banks have an open row and manage the issuance of precharge commands to close open rows before a subsequent activation command can be directed to the same bank. In addition to commands that directly cause an activation operation, certain commands may cause an internal activate or precharge operation as a side effect of their execution. For example, a read with auto-precharge command causes the memory device to perform an internal precharge after the read operation completes. In various aspects described herein, the term activation command encompasses any command that causes an internal activate operation or a command that causes a precharge operation in a memory bank.

A memory device includes a plurality of memory banks, and each memory bank includes a plurality of memory rows. A memory bank is independently accessible. As such, activation commands directed to different memory banks may be issued and processed concurrently, which may enable the memory controller to interleave accesses to different banks within the command stream. A memory row may be the smallest unit of memory that is activated as a whole. The memory controller may specify a complete row address in the activation command, and the entire selected row is connected to the sense amplifiers via the bit lines upon activation. Memory banks may further be organized into bank groups, where banks within the same bank group share certain timing constraints, and banks in different bank groups can be accessed with reduced inter-command timing gaps.

A refresh management command may refer to a command issued by the memory controller to the memory device that instructs the memory device to perform a mitigation refresh operation targeting one or more memory rows within one or more memory banks. The refresh management command may specify a memory bank address identifying the memory bank to which the command is directed, but the command does not necessarily specify a memory row address. For example, the memory device may determine the target row or rows internally based on information maintained within the device. Variants of the refresh management command can differ in the scope of the banks targeted. For example, a per-bank refresh management command targets a single specified memory bank. Additionally, or alternatively, a subset-targeting refresh management command targets a subset of the plurality of memory banks, including the specified memory bank, such as one bank per bank group. In another example, an all-bank refresh management command targets all memory banks within the memory device.

A per-row activation counting (PRAC) may refer to a mechanism implemented within the memory device whereby the device maintains internal counters that track the number of activation commands received per row, or per group of rows, within each memory bank. When the activation count for a given memory row approaches a critical threshold, the memory device can use the internally maintained per-row activation counts to identify memory rows that have received a disproportionately large number of activations and are therefore likely aggressor rows. Upon receiving a refresh management command specifying a memory bank, the memory device may use the per-row activation counts maintained for that bank to select one or more rows for mitigation.

In various aspects described herein, an alert signal may refer to a signal asserted by the memory device to the memory controller on a dedicated pin or sideband channel when the internal per-row activation count for a memory row reaches a predefined limit. Upon detecting the assertion of the alert signal, the memory controller may be configured to respond by issuing a refresh management command and stalling normal memory traffic for a period sufficient to allow the memory device to complete the mitigation operation. This stall period may range from approximately 1 microsecond to tens of microseconds depending on system configuration. Under memory access patterns that repeatedly activate the same rows at high rates, the memory device may assert the alert signal thousands of times per second, with each assertion imposing the associated latency penalty on normal memory operations. The alert signal mechanism may be reactive, and it may require the memory device to detect a threshold condition before the memory controller takes action — and operates in addition to any proactive refresh management commands that the memory controller may issue.

Directed refresh management may be an approach including two distinct controller-side steps. First, the memory controller sets a flag in a per-bank precharge command, a read with auto-precharge command, or a write with auto-precharge command directed to a memory bank, which signals the memory device to internally capture and store the row address associated with the command. Second, the memory controller subsequently issues a directed refresh management command, either that is an all-bank variant targeting all memory banks, or a same-bank variant targeting one bank per group across all bank groups. The directed refresh management command does not itself carry a row address. The memory device uses the row address captured in the first step to perform mitigation, refreshing memory rows adjacent to the captured row as the suspected aggressor row. DRFM commands in specifications such as DDR5 target multiple banks simultaneously, such that they are either all banks or the same bank across all bank groups, rather than a single specified bank. DRFM is not available in LPDDR6 specifications.

In various aspects described herein, the memory controller may apply a sampling criterion to each detected activation command to determine whether to issue a refresh management command for the memory bank to which the activation command was directed. For example, when the sampling criterion indicates that a refresh management command should be issued, the memory controller may issue that command specifying the memory bank address without specifying a memory row address. The memory device, upon receiving the refresh management command, can select the target memory row or rows internally using its per-row activation counts, identifying the rows most likely to be aggressor rows based on the device's own activation tracking. This approach does not require the memory controller to capture or supply a row address, and does not require the memory controller to maintain individual activation counts per memory bank.

As hinted above, this sampling-based determination may operate without requiring the memory controller to maintain individual activation counts per memory bank. Existing approaches, such as the bank activation threshold mechanism, may require the memory controller to allocate a dedicated counter for each memory bank in the system and to evaluate a per-bank threshold condition on every activation. By contrast, the sampling criterion may operate on individual activation commands as they are detected, using either a probabilistic criterion or a single global activation counter. In various aspects, when the sampling criterion indicates that a refresh management command should be issued, the refresh management command specifies the memory bank address of the detected memory bank without specifying a memory row address. The memory device selects the target row internally based on per-row activation counts maintained by the memory device. This delegation of row address selection to the memory device eliminates the controller-side address capture step that directed refresh management requires, and allows the memory device to apply its internal per-row activation tracking to identify the most likely aggressor rows at the time the refresh management command is received.

In various aspects, because the sampling criterion is applied at the point of each individual activation command, memory banks that receive activation commands at a higher rate can be subjected to the sampling criterion more frequently, and therefore receive refresh management commands at a correspondingly higher rate. Memory banks that receive no activation commands receive no refresh management commands. This proportional relationship between the activation rate per bank and the refresh management command rate per bank arises naturally from the per-command sampling approach, without requiring the memory controller to explicitly track per-bank activation rates. In various aspects, when the sampling criterion is probabilistic, in which the result is determined based on a random or pseudo-random event generated in response to each detected activation command, the timing of refresh management command issuance is non-deterministic with respect to the timing of the activation commands. This non-deterministic issuance property can contrast with periodic approaches, in which refresh management commands are issued at fixed time intervals that an attacker may observe or infer, and with per-bank counter-based approaches, in which the trigger point for each bank is predictable from knowledge of the counter threshold.

In various aspects, the sampling criterion includes a sampling parameter that controls the rate of issuance of refresh management commands relative to the number of detected activation commands. This sampling parameter may be configurable and may be adjusted, for example based on a reliability characteristic of the memory device. As memory device reliability changes over the device lifetime or varies across device types, for example, as the Rowhammer threshold decreases with device aging or with advancing process technology, the sampling parameter may be adjusted to modify the refresh management command rate accordingly. The reliability characteristic may include frequency of alert signal assertions. If there are many alerts, that could indicate that the memory circuit (e.g., DRAM) is less reliable. In an example, the sampling parameter may also be adjusted based on the observed frequency of alert signal assertions received by the control circuitry. For example, if the frequency of alert signal assertions exceeds a target threshold, the sampling parameter may be decreased to increase the rate of proactive refresh management command issuance, or if alert signal assertions occur at a negligible rate, the sampling parameter may be increased to reduce command bus occupancy without compromising mitigation effectiveness. For a counter-based sampling criterion, the sampling parameter corresponds to the threshold value at which the activation counter triggers issuance and is subsequently reset. For a probabilistic sampling criterion, the sampling parameter corresponds to the probability value against which the random or pseudo-random event is evaluated. In both cases, the parameter can provide a configurable control over the aggressiveness of the proactive mitigation performed by the memory controller.

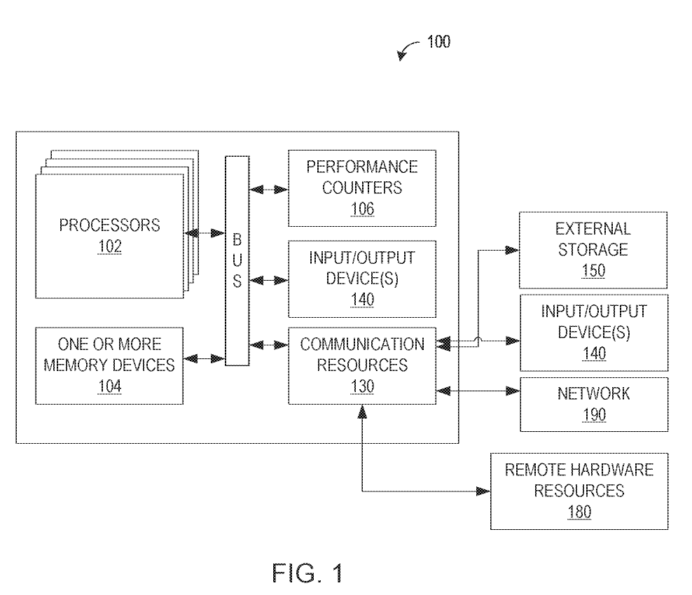

FIG. 1 illustrates a block diagram of an example computing system 100 in accordance with various aspects described herein. The computing system 100 typically includes a system of interconnected hardware and software resources configured to execute instructions, process data, and manage the allocation of computational capabilities. The computing system 100 may be a server, a workstation, a cluster of servers, a data center, a mobile computing platform, a client computing device, or a cloud computing infrastructure. External storage 150, network 190, external input and output devices 140, and remote hardware resources 180 connect to the hardware resources via the communication resources 130 and input and output devices 140.

The computing system 100 generally includes one or more processors 102, one or more memory devices 104, a bus, communication resources 130, and one or more input/output devices 140. The processors 102 represent the computational core of the computing system 100 and each processor among the processors 102 may integrate a cache hierarchy and a memory controller interface through which the processor 102 initiates memory transactions directed to the one or more memory devices 104. The memory controller interface includes a physical interface layer that includes the signal connections. The physical interface layer may further facilitate timing relationships, and implement data transfer protocols through which the processor 102 communicates with the one or more memory devices 104. The physical interface layer also carries sideband signals between the memory controller and the one or more memory devices 104, including an alert signal path through which a memory device 104 asserts an alert signal to the memory controller when an internal per-row activation count for a memory row reaches a predefined limit. The capacity of the memory subsystem accessible through this interface may be based in part on the number and configuration of memory devices 104 coupled to the interface.

The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

Each processor among the processors 102 communicates with the one or more memory devices 104 through a memory controller that manages command scheduling, address mapping, rank selection, refresh management, and coordination of data transfers, incorporating timing control logic that enforces the temporal constraints imposed by the memory interface specification. The memory controller issues activation commands to open memory rows within specified memory banks for read and write operations, and issues refresh management commands to the one or more memory devices 104 to trigger mitigation operations for memory rows that may be subject to disturbance effects arising from repeated activation of neighboring rows. The memory controller may issue refresh management commands proactively based on a sampling criterion applied to detected activation commands, and may also issue refresh management commands reactively in response to the assertion of an alert signal by a memory device 104. The memory controller may include a data interface having a designated data width and a read data strobe input through which the memory controller receives timing reference signals from the one or more memory devices 104, using those timing reference signals to determine the correct sampling instants for data received on the data interface.

In some examples, the one or more processors 102 may execute instructions (e.g., non-transitory computer-readable instructions). Instructions may include software, program code, application(s), applet(s), app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In some configurations, the one or more memory devices 104 include low-power double data rate memory devices coupled to the memory controller of the processor 102 over one or more memory channels, with each memory channel including a set of data lines, a write clock line, a command and address bus, one or more chip select lines, and a read data strobe line. Each memory device 104 includes a plurality of memory banks, each memory bank including a plurality of memory rows, and may support per-row activation counting whereby the device maintains internal counters tracking the number of activation commands received per row within each bank.

As examples, the memory devices 104 can be or can include random access memory (RAM), static RAM (SRAM), dynamic RAM (DRAM), synchronous DRAM (SDRAM), dual inline memory modules (DIMMs), small outline compression attached memory modules (SOCAMMs), microDIMMs, MiniDIMMs, or other volatile memory devices. The one or more memory devices 104 may conform to memory-related specifications including LPDDR6, DDR6, HBM5, GDDR7, or other current or future DRAM specifications that support per-row activation counting. Each memory device 104 may be packaged individually or in a vertically stacked arrangement within a common package, and may include one or more independently addressable ranks accessible via respective chip select signals.

The processors 102 and the one or more memory devices 104 communicate via a bus or an interconnect system. The bus represented in FIG. 1 generally illustrates the data pathways within the computing system 100. The memory interface between the memory controller and each memory device 104 carries multiple physical signal groups: unidirectional command and address signals on the command and address bus, chip select signals, a differential system clock, bidirectional data signals that carry read and write data and data strobes between the memory controller and the memory devices 104, and sideband signals including the alert signal path through which a memory device 104 signals to the memory controller that an internal per-row activation count has reached a limit. The alert signal path and the command and address bus together form the primary communication channel through which the memory controller and the memory device 104 coordinate refresh management operations.

The communication resources 130 enable the computing system 100 to exchange data with external entities. The communication resources 130 may include one or more network interface controllers, host bus adapters, or input/output fabric interfaces. The network interface controllers may support various communication standards, such as Ethernet, Wi-Fi, InfiniBand, or Fibre Channel. The communication resources 130 manage the physical and data link layers of the communication protocols, handling the transmission and reception of data packets. The communication resources 130 connect the computing system 100 to a network 190. The network 190 may be a local area network, a wide area network, the internet, or a dedicated storage area network. Through the network 190, the computing system 100 may access remote hardware resources 180 and external storage 150.

The computing system 100 may include multiple memory channels, each with its own independent command and address bus, data bus, and sideband signal path. Each memory channel connects to one or more memory devices 104 and is independently controlled by the memory controller. Within each channel, memory may be organized into one or more ranks, where each rank includes a set of memory devices 104 accessed in parallel in response to a single activation command, and into subchannels representing independent data paths within the channel. The memory controller manages activation commands and refresh management commands across all ranks and subchannels within each channel. Performance counters (106) accessible via the bus may be used to monitor memory access patterns, including activation rates, across the memory channels of the computing system 100.

The input/output devices 140 associated with the computing system 100 represent local peripheral interfaces and devices. These may include storage controllers, universal serial bus controllers, and interfaces for human interaction devices. The input/output devices 140 may also include hardware accelerators, such as field-programmable gate arrays or application-specific integrated circuits, installed to offload specific processing tasks from the processors 102. These peripheral components generate memory traffic that flows through the memory controller, contributing to the aggregate activation command rate seen by the one or more memory devices 104, and therefore to the activation patterns that the memory controller monitors for purposes of refresh management.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the computing system 100 may function as one physical node in a larger cluster, with the remote hardware resources 180 constituting the other physical nodes. The remote hardware resources 180 may possess similar or different configurations compared to the computing system 100. The ability to communicate with the remote hardware resources 180 enables distributed processing, where a single large task is decomposed into smaller sub-tasks executed in parallel across multiple machines.

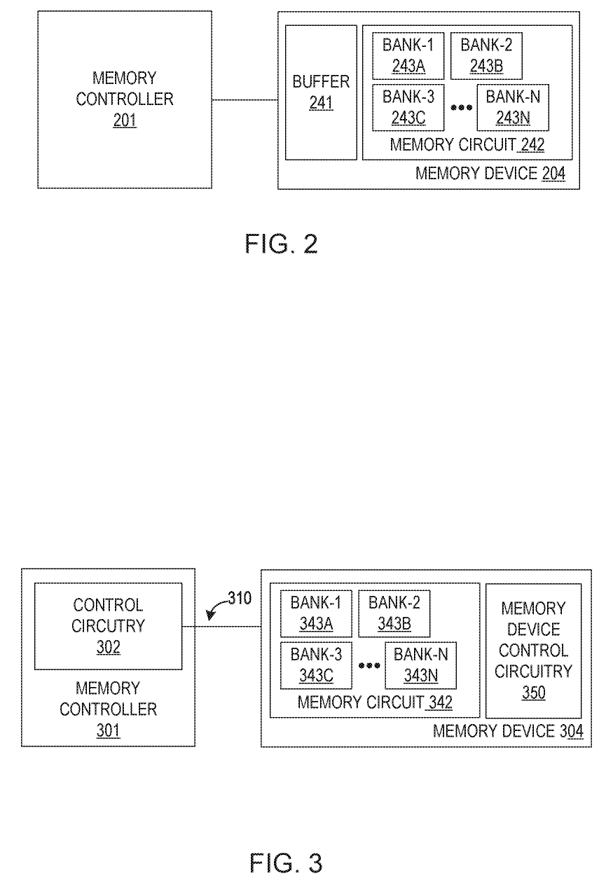

The computing system 100 described with reference to FIG. 1 provides the environment in which the memory system described in further detail with reference to FIG. 2 operates. The memory controller and the one or more memory devices 104 of the computing system 100, together with the command and sideband signal interfaces connecting them, form the memory system within which the refresh management techniques described herein may be implemented.

FIG. 2 illustrates a memory system including a memory controller 201 integrated within or coupled to a processor, and a memory device 204 coupled to the memory controller 201 via a command and address interface, a data interface, and a signal path (e.g., a sideband signal path). The memory device 204 includes a memory circuit 242 that includes a plurality of memory banks, specifically bank-1243A, bank-2243B, bank-3243C, through bank-N 243N, each memory bank including a plurality of memory rows. The memory device 204 further may include a buffer 241 that interfaces between the command and address interface and the memory circuit 242. The buffer 241 may decode commands received from the memory controller 201 and direct internal operations to the appropriate memory bank within the memory circuit 242. The sideband signal path may carry an alert signal from the memory device 204 to the memory controller.

The memory controller 201 issues activation commands to the memory device 204, each activation command specifying a memory bank address identifying one of the memory banks 243A–243N and a memory row address identifying a memory row within that memory bank. Upon receipt of an activation command, the buffer 241 may decode the command and cause the memory circuit 242 to open the specified memory row within the specified memory bank, connecting the memory cells of that row to the sense amplifiers of the bank via the bit lines for subsequent read or write operations. After the read or write operation is complete, the memory controller 201 may issue a precharge command to close the open row, returning the specified memory bank to a state in which a subsequent activation command may be directed to the same bank. In addition to commands that explicitly cause an activation or precharge operation, certain commands may cause an internal activate or precharge operation as part of their execution. For example, a read with auto-precharge command causes the memory circuit 242 to perform an internal precharge after the read operation completes, and a write with auto-precharge command similarly causes an internal precharge after the write operation completes.

Each memory bank 243A–243N within the memory circuit 242 may include a row decoder, sense amplifiers, and a row buffer that together implement the activate-access-precharge cycle. The row decoder may be configured to apply selection voltages to the word line corresponding to the memory row address specified in the activation command, connecting the memory cells of the selected row to the sense amplifiers via the bit lines. The sense amplifiers may be configured to detect and amplify the charge state of each memory cell in the selected row, and the row buffer may hold the amplified data for the duration of the access. The memory banks 243A–243N may operate independently of one another, such that activation commands directed to different memory banks may be issued in an interleaved sequence, and the memory circuit 242 may have multiple memory banks simultaneously in an open state.

The memory circuit 242 may be configured to implement per-row activation counting within each memory bank 243A–243N. For each memory bank, the memory circuit 242 may be configured to maintain a counting structure that tracks the number of activation commands received per memory row, or per group of memory rows, within that bank. In an example, the counting structure includes count values stored in DRAM cells within the memory circuit 242 together with incrementing logic that increments the count value associated with a memory row each time an activation command directed to that row is received via by the memory device 204.When the activation count for a given memory row approaches or reaches a critical threshold associated with a predefined threshold (e.g., the Rowhammer threshold) of the memory device 204, the memory circuit 242 may identify that row as a likely aggressor row. The per-row activation counting logic may be internal to the memory device 204 and operate independently of any tracking performed by the memory controller 201. The memory device 204 may conform to a DRAM specification that defines per-row activation counting as a supported feature, such as LPDDR6.

When the per-row activation count for a memory row within any of the memory banks 243A–243N reaches a predefined limit, the memory device 204 may assert the alert signal on the sideband signal path to the memory controller 201. Upon detecting the assertion of the alert signal, the memory controller 201 may be required to respond by issuing a refresh management command to the memory device 204. The memory controller 201 may further be required to stall (normal) memory traffic for a period sufficient to allow the memory device 204 to complete the associated mitigation operation. This stall period may range from approximately 1 microsecond to approximately tens of microseconds depending on system configuration. Under memory access patterns in which an aggressor row is repeatedly activated at a high rate, as occurs in a Rowhammer attack, the memory device 204 may assert the alert signal thousands of times per second.

Upon receiving a refresh management command specifying a memory bank address, the memory circuit 242 may be configured to use the per-row activation counts maintained internally for the specified memory bank to select at least one memory row within that bank for mitigation. The memory circuit 242 may select the memory row or rows that have accumulated the highest activation counts within the specified bank, identifying those rows as the most likely aggressor rows at the time the refresh management command is received. Additionally, or alternatively, the memory circuit 242 may store row addresses of the first row that reaches a designated threshold and select the memory row or rows based on those stored row addresses. The memory circuit 242 may then be configured to perform a refresh operation on one or more memory rows adjacent to the selected memory row or rows, restoring the charge in those adjacent rows, which are the potential victim rows of repeated activation of the selected aggressor row. The row address selection and the adjacency determination may be performed entirely within the memory device 204, without the memory controller 201 specifying a memory row address in the refresh management command.

The refresh management command issued by the memory controller 201 may take one of several forms that differ in the scope of memory banks targeted. For example, a per-bank refresh management command specifies a single memory bank address and causes the memory circuit 242 to perform the mitigation operation for that single memory bank. For example, a subset-targeting refresh management command specifies a memory bank address and causes the memory circuit 242 to perform the mitigation operation for a subset of the plurality of memory banks that includes the specified memory bank, illustratively, one memory bank per bank group within the memory device 204. For example, an all-bank refresh management command causes the memory circuit 242 to perform the mitigation operation for all memory banks within the memory device 204. The scope of the refresh management command affects the number of memory banks for which mitigation is performed in response to a single command and the occupancy of the command and address interface during command issuance.

The memory system described with reference to FIG. 2 can establish the command protocol and the device-side mechanisms through which the memory controller 201 and the memory device 204 cooperate to perform Rowhammer mitigation. The following description with reference to FIG. 3 describes the control circuitry within the memory controller 201 that implements the sampling-based determination of when and for which memory bank to issue refresh management commands.

FIG. 3 illustrates an apparatus including a memory controller 301 that includes control circuitry 302 and an interface 310 coupled to a memory device 304. The apparatus may further include the memory device 304 coupled to the memory controller 301 via the interface 310. The apparatus may be implemented in a computing system (e.g., the computing system 100). The computing system may include a memory system including a memory controller (e.g., the memory controller 201) and a memory device (e.g., the memory device 204).

The memory device 304 includes a memory circuit (342) that includes a plurality of memory banks, specifically bank-1 (343A), bank-2 (343B), bank-3 (343C), through bank-N (343N), each memory bank including a plurality of memory rows. The memory device 304 may include memory device control circuitry 350 that implements memory-device-side operations including per-row activation counting and the execution of mitigation operations in response to refresh management commands received from the memory controller 301. The control circuitry 302 of the memory controller 301 may implement a sampling-based mechanism for determining when to issue refresh management commands to the memory device 304.

The interface 310 is a hardware interface that couples the control circuitry 302 to the memory device 304. The interface 310 carries command and address signals, data signals, and sideband signals between the memory controller 301 and the memory device 304. Command and address signals may carry activation commands, precharge commands, refresh management commands, and other commands issued by the control circuitry 302 to the memory device 304. Sideband signals may include the alert signal path through which the memory device control circuitry 350 may be configured to assert an alert signal to the control circuitry 302 when an internal per-row activation count for a memory row within one of the memory banks 343A–343N reaches a predefined limit. The interface 310 may conform to a DRAM interface specification such as LPDDR6 or DDR6. In an example, the interface 310 implements a low-power double data rate physical interface in which the command and address signals and the alert signal are carried on separate signal paths, enabling the memory device 304 to assert the alert signal asynchronously with respect to command and address signal timing.

The control circuitry 302 may include logic for command scheduling, refresh management, and the sampling-based determination as described herein. The control circuitry 302 may monitor the stream of commands issued via the interface 310, detect activation commands within that stream, apply a sampling criterion to each detected activation command, and/or selectively issue refresh management commands based on the result of such an application. The control circuitry 302 may be implemented as dedicated hardware logic, a finite state machine, microcode executing on a programmable logic element, or a combination of such implementations. The control circuitry 302 may be integrated on the same die as a processor that generates memory access requests, or may be implemented on a discrete memory controller device. In addition to various aspects, such as sampling-based refresh management, described herein, the control circuitry 302 may be configured to manage the full range of memory controller functions including activation scheduling, read and write command scheduling, precharge management, and standard periodic refresh.

The control circuitry 302 may be configured to detect an activation command directed to a memory bank of the plurality of memory banks 343A–343N. In an example, detection may refer to identifying, within the command stream issued via the interface 310, a command that causes a memory row within a specified memory bank to be opened for access. For example, detection may involve the control circuitry 302 observing commands as they are issued or scheduled for issuance via the interface 310. The detection may further include the control circuitry 302 identifying commands that qualify as activation commands, and extracting from each such command the memory bank address that identifies the target memory bank. In an example, the control circuitry 302 may include command monitoring logic positioned within the command scheduling path, so that every command issued via the interface 310 is presented to the monitoring logic before transmission. The monitoring logic may decode the command type field and, upon identifying a qualifying activation command, capture the memory bank address from the command encoding. From the perspective of the memory device control circuitry 350, each received activation command may independently cause the memory device control circuitry 350 to update the internal per-row activation count maintained for the activated memory row within the targeted bank, which may be an operation that proceeds in parallel with the control circuitry 302's detection and sampling-criterion evaluation.

For the purposes of detection by the control circuitry 302, an activation command may encompass any command whose receipt by the memory device 304 causes an internal activate operation or an internal precharge operation within a memory bank of the memory device 304. This definition includes explicit activation commands that open a specified memory row within a specified memory bank, and also includes commands that cause these operations as a side effect. For example, a read with auto-precharge command causes the memory device control circuitry 350 to perform an internal precharge operation after the read completes, and a write with auto-precharge command similarly causes an internal precharge after the write completes. By encompassing this broader set of commands, the control circuitry 302 can ensure that the sampling criterion is applied to all commands that advance per-row activation counts within the memory device 304, including those that cause implicit internal operations. In an example, the control circuitry 302 identifies qualifying activation commands by decoding one or more fields of the command encoding received on the command and address path of the interface 310, including the command type field and, where applicable, an auto-precharge indicator field. The memory bank address extracted from the qualifying command is the bank address for which the control circuitry 302 subsequently evaluates the sampling criterion.

The control circuitry 302 may be configured to determine, based on a sampling criterion, a result representing whether to issue a refresh management command in response to the detected activation command. The sampling criterion may refer to a decision rule applied by the control circuitry 302 to each detected activation command individually, producing a result that indicates whether a refresh management command should be issued for the memory bank targeted by that activation command. In an example, the sampling criterion defines the conditions under which a detected activation command is selected as a trigger for refresh management command issuance.

For example, the sampling criterion may be a probabilistic criterion, for example, in which the result is determined by a random or pseudo-random event generated in response to the detected activation command. Additionally, or alternatively, the sampling criterion may be a counter-based criterion, for example, in which the result is determined by comparing the current value of an activation counter against a threshold value. In an example, a probabilistic criterion may be implemented using a linear feedback shift register that generates a pseudo-random output value on each detected activation command, compared against a configurable threshold. A counter-based criterion may be implemented using a hardware counter that is incremented on each detected activation command and compared against a configurable threshold value. In both cases, the sampling criterion is applied at the point of each individual activation command.

The result obtained by the application of the sampling criterion may be a representation, internal to the control circuitry 302, of whether a refresh management command should be issued in response to the detected activation command. In an example, the result is a binary indication, which indicates to issue or not to issue. This governs the subsequent behavior of the control circuitry 302 with respect to that detected activation command. For example, the result may indicate two possible outcomes, namely a first outcome in which the result indicates that a refresh management command should be issued directed to the memory bank identified by the detected activation command, and a second outcome in which the result indicates that no refresh management command should be issued and the control circuitry 302 returns to monitoring for the next activation command. In an example, the result may be represented as a single-bit signal produced by comparison logic within the sampling criterion circuit, for example, the output of a magnitude comparator comparing the activation counter value against a threshold, or the output of a threshold comparison applied to a pseudo-random number. The result may be associated with the specific memory bank identified by the activation command that triggered its generation.

When the result indicates issuance, the control circuitry 302 may be configured to issue the refresh management command directed to the memory bank via the interface 310. In an example, issuing the refresh management command may include transmitting a command via the interface 310 that instructs the memory device control circuitry 350 to perform a mitigation refresh operation for the memory bank identified by the result. For example, the control circuitry 302 constructs the refresh management command to include a memory bank address identifying the memory bank that was the target of the detected activation command, and issues this command via the command and address path of the interface 310. In an example, the issued command is without including a memory row address in the command encoding. For example, the control circuitry 302 may insert the refresh management command into the command scheduler of the memory controller 301, where the command is scheduled for issuance via the interface 310 subject to the timing constraints of the applicable memory interface specification. In an example, the refresh management command may be formatted as an RFMpb command addressed to the detected bank, in accordance with the LPDDR6 specification command encoding.

For example, the control circuitry 302 observes the command stream on the memory controller side, detecting activation commands and evaluating the sampling criterion, preferably without requiring information from the memory device 304 to make the issuance determination. The determination may be made locally within the control circuitry 302 based on the identity of the detected activation command and the state of the sampling criterion. The interface 310 may carry both the activation commands that the control circuitry 302 detects and the refresh management commands that the control circuitry 302 issues as a result of the sampling determination.

The memory device control circuitry 350, upon receiving an activation command via the interface 310, may independently update the per-row activation counts maintained for the targeted memory bank. Upon subsequently receiving a refresh management command via the interface 310, the memory device control circuitry 350 may use these internally maintained per-row activation counts to select the target memory row for mitigation, preferably without requiring the control circuitry 302 to supply a row address. This division of responsibilities, which involves the control circuitry 302 determining when to issue, and the memory device control circuitry 350 determining which row to target, may be one of the structural characteristics of the apparatus described herein.

In an example, the activation command detected by the control circuitry 302 includes at least one of a command causing an internal activate operation or a command causing a precharge operation in the memory bank. An explicit activation command can cause the memory device control circuitry 350 to open the specified memory row within the specified memory bank by applying selection voltages to the corresponding word line within the memory circuit 342. A command causing an internal precharge operation, such as a read with auto-precharge command or a write with auto-precharge command, can cause the memory device control circuitry 350 to close the open row in the specified memory bank after the access operation completes. The control circuitry 302 identifies the target memory bank from the bank address field of the detected activation command and retains this identity for use in constructing the refresh management command if the sampling criterion result indicates issuance. In an example, the command monitoring logic of the control circuitry 302 may decode the command type field and an auto-precharge indicator field of each command transmitted via the interface 310 to determine whether the command qualifies as an activation command for the purposes of the sampling criterion.

Upon detecting an activation command, the control circuitry 302 applies the sampling criterion to determine the result. In a first embodiment, the control circuitry 302 applies a probabilistic criterion as the sampling criterion. This first embodiment may include the control circuitry 302 generating a random or pseudo-random event in response to each detected activation command and evaluating whether that event satisfies the criterion. In a second embodiment, the sampling criterion is based on an activation counter maintained by the control circuitry 302. In the second embodiment, the activation counter may indicate a counted number of received activation commands, and the result may represent issuance when the value of the activation counter reaches a threshold value.

In both embodiments, the control circuitry 302 may determine the result independently of individual activation counts maintained per memory bank of the plurality of memory banks 343A–343N. The control circuitry 302 does not maintain a separate activation counter for each memory bank, which collectively facilitates this independence from per-bank activation counts, such that the control circuitry 302 that distinguishes the sampling-based approach from approaches that require dedicated per-bank counter hardware scaled to the total number of banks in the system.

In an example, the refresh management command issued by the control circuitry 302 specifies a memory bank address identifying the memory bank targeted by the detected activation command, preferably without specifying a memory row address. The memory bank address may be extracted from the detected activation command and included in the refresh management command encoding transmitted via the interface 310. The absence of a memory row address in the refresh management command may refer to that it is the memory device control circuitry 350 that determines the target row for the mitigation operation using its own internally maintained per-row activation counts, rather than relying on a row address supplied or selected by the control circuitry 302. This can contrast with directed refresh management, in which the memory controller first selects a row address for the DRAM to capture by setting a flag in the precharge command.. By omitting the row address selection, the control circuitry 302 can eliminate the address capture step and allow the memory device control circuitry 350 to apply its internal per-row activation tracking to identify the most likely aggressor row at the time the command is received.

In an example, the refresh management command issued by the control circuitry 302 is a per-bank refresh management command targeting the memory bank identified by the detected activation command. A per-bank refresh management command can specify a single memory bank address and causes the memory device control circuitry 350 to perform the mitigation operation for that single bank, leaving the remaining memory banks 343A–343N unaffected by that command. The control circuitry 302 may construct the per-bank refresh management command by encoding the bank address of the detected memory bank in the bank address field of the command, in accordance with the format defined by the applicable memory interface specification. In an example conforming to an LPDDR6 specification, the per-bank refresh management command is formatted as an RFMpb command addressed to the bank that was the target of the detected activation command.

In an example, the refresh management command issued by the control circuitry 302 targets a subset of the plurality of memory banks 343A–343N, the subset including the memory bank that was the target of the detected activation command. A subset-targeting refresh management command may specify a memory bank address and cause the memory device control circuitry 350 to perform the mitigation operation for a subset of memory banks that includes the specified bank where the specified bank is the targeted bank within its bank group. For example, the specified bank may be one memory bank per bank group within the memory circuit 342. The control circuitry 302 may select the subset-targeting command variant when configured to extend the scope of each refresh management command beyond a single bank while still triggering issuance based on the sampling of a specific detected activation command. This variant may allow multiple banks to receive mitigation in response to a single command issuance, reducing command bus occupancy per bank mitigated relative to issuing individual per-bank commands for each bank.

As indicated before, the apparatus may further include the memory device 304. In an example, the memory device 304 is configured to, in response to the refresh management command received from the control circuitry 302 via the interface 310, internally select at least one memory row within the targeted memory bank based on per-row activation counts maintained by the memory device control circuitry 350. Upon receiving the refresh management command, the memory device control circuitry 350 may examine the per-row activation counts maintained for each memory row within the specified memory bank and identify the memory row or rows that have accumulated the highest activation counts. These identified memory row or rows may correspond to the most likely aggressor rows. The row selection may be performed entirely within the memory device 304. For example, the control circuitry 302 does not supply or select a row address in the refresh management or the precharge command, and the memory device control circuitry 350 applies its internal, continuously updated per-row activation tracking to make the selection. In an example, the memory device control circuitry 350 selects the memory row with the highest per-row activation count within the specified bank as the suspected aggressor row for the mitigation operation. Additionally, or alternatively, the memory device control circuitry 350 may store row addresses of the first row that reaches a designated threshold and select the memory row or rows based on those stored row addresses.

In an example, the memory device 304 is configured to perform a refresh operation on one or more memory rows adjacent to the at least one internally selected memory row. After the memory device control circuitry 350 selects the suspected aggressor row based on per-row activation counts, the memory device control circuitry 350 identifies the memory rows physically adjacent to the selected row within the memory circuit 342 and performs a targeted refresh operation on those adjacent rows, restoring the charge stored in those rows. The adjacent rows may be the potential victim rows of the Rowhammer disturbance, since they are the rows that accumulate charge leakage due to repeated activation of the selected aggressor row. The adjacency determination may use an internal array map maintained by the memory device control circuitry 350, which accounts for any address swizzling or row repair remapping applied within the memory circuit 342, without requiring the control circuitry 302 to know the internal physical row layout of the memory device 304. In an example, the memory device control circuitry 350 also performs a refresh operation on the selected aggressor row itself in addition to the adjacent victim rows, because resetting the per-row activation count associated with the selected row, which may be stored in DRAM cells within the counting structure, requires a write operation to those cells.

In an example, the control circuitry 302 is configured to determine the result independently of individual activation counts maintained per memory bank of the plurality of memory banks 343A–343N. For example, the control circuitry 302 does not allocate or maintain a dedicated activation counter for each memory bank.

In the counter-based sampling criterion embodiment, the control circuitry 302 may maintain a single activation counter incremented in response to activation commands directed to any memory bank. In other words, the counter is not partitioned by bank address, and the control circuitry 302 does not distinguish between activation commands directed to different banks for counter management purposes. In the probabilistic sampling criterion embodiment, the result may be determined by a pseudo-random event generated without reference to any per-bank activation history. In both cases, the control circuitry 302 can determine the result based solely on the state of the sampling criterion at the time the activation command is detected. This may eliminate the need for per-bank counter resources in the control circuitry 302, the number of which would otherwise scale with the total number of memory banks across all ranks and subchannels accessible via the interface 310.

In an example, the memory device 304 includes a dynamic random-access memory device configured to support per-row activation counting. The apparatus described with reference to FIG. 3 is applicable to any memory device that supports per-row activation counting and that accepts refresh management commands specifying a memory bank address without a memory row address. The approach does not require modifications to the memory device 304, since the control circuitry 302 issues standard refresh management commands as defined by the applicable specification, and the memory device control circuitry 350 uses the per-row activation counting mechanism defined in that specification to select the target row for mitigation.

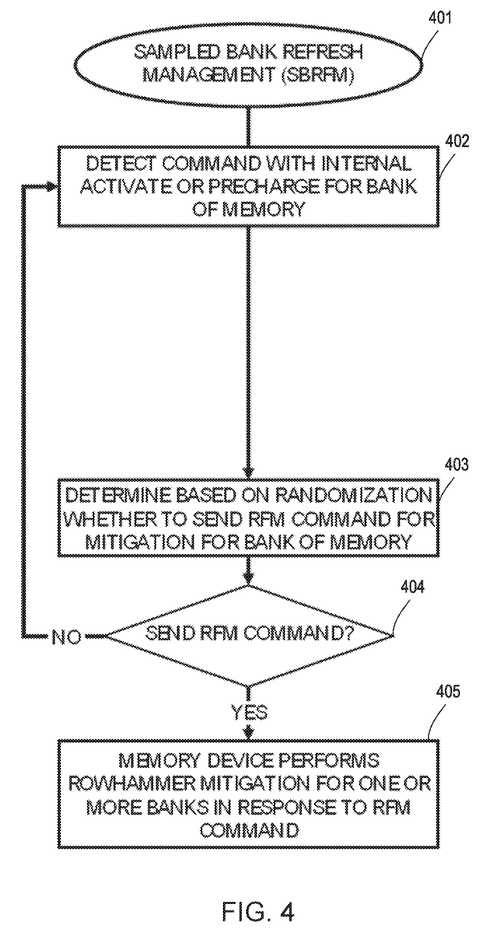

FIG. 4 illustrates a flowchart of a sampled bank refresh management operation 401, which the control circuitry 302 of the apparatus may perform. The operation may begin when the control circuitry 302 enters a monitoring state in which the control circuitry 302 observes each command issued via the interface 310 to the memory device 304. The flowchart depicts the sequence through which the control circuitry 302 detects an activation command, applies a sampling criterion to determine a result, and either issues a refresh management command directed to the detected memory bank or returns to monitoring, as well as the response of the memory device 304 upon receiving a refresh management command. The flowchart of FIG. 4 is described with reference to both the probabilistic criterion embodiment and the counter-based criterion embodiment of the sampling criterion.

In 402, the control circuitry 302 detects a command with an internal activate or precharge operation directed to a memory bank of the memory device 304. The control circuitry 302 may continuously monitor the command stream issued via the interface 310 and identify commands that qualify as activation commands for the purposes of the sampling criterion. A qualifying activation command includes at least one of a command causing an internal activate operation within a memory bank or a command causing a precharge operation within a memory bank. In an example, monitoring explicit activate commands directed to a memory bank is sufficient for the control circuitry 302 to detect the commands that advance the per-row activation counts within the memory device control circuitry 350.

Examples of qualifying commands include explicit activation commands that open a specified memory row within a specified memory bank, read with auto-precharge commands that cause an internal precharge operation after the read completes, and write with auto-precharge commands that cause an internal precharge operation after the write completes. The control circuitry 302 may extract the memory bank address from the detected activation command, identifying which of the memory banks 343A–343N is the target. This extracted bank address may be retained by the control circuitry 302 for use in constructing the refresh management command if the subsequent determination indicates issuance.

In 403, the control circuitry 302 may perform the determination, based on the sampling criterion, of whether to issue a refresh management command for the memory bank identified at 402. The control circuitry 302 may apply the sampling criterion to the detected activation command to produce a result representing whether a refresh management command should be issued. As mentioned before, two embodiments of the sampling criterion may be present: a probabilistic criterion embodiment and a counter-based criterion embodiment. In both embodiments, the determination may be made by the control circuitry 302 based solely on the state of the sampling criterion at the moment the activation command is detected, without reference to individual activation counts maintained per memory bank. The sampling criterion is applied to each detected activation command individually, so that every qualifying command entering the monitoring loop at 402 is subjected to the determination at 403.

In the probabilistic criterion embodiment, the control circuitry 302 applies a probabilistic criterion as the sampling criterion. For each detected activation command at 402, the control circuitry 302 may generate a random or pseudo-random event and evaluate whether that event satisfies the probabilistic criterion. In an example, the control circuitry 302 generates a pseudo-random number using a linear feedback shift register and compares the generated value against a configurable probability threshold. If the generated value satisfies the comparison, for instance, if the pseudo-random value falls below the threshold, the result indicates that a refresh management command should be issued. If the generated value does not satisfy the comparison, the result indicates that no command should be issued. The probability threshold may determine the average rate at which refresh management commands are issued relative to the rate of detected activation commands. By adjusting the probability threshold, the control circuitry 302 can control the average number of activation commands per refresh management command issuance.

In the counter-based criterion embodiment, the sampling criterion is based on an activation counter maintained by the control circuitry 302. The activation counter indicates a counted number of received activation commands. Each time the control circuitry 302 detects a qualifying activation command at 402, the control circuitry 302 increments the activation counter. The activation counter may be a single counter maintained by the control circuitry 302 for use across all memory banks accessible via the interface 310. In this example, the control circuitry 302 does not maintain separate counters for individual memory banks. In an example, the activation counter may be implemented as a hardware register of sufficient bit width to represent the configured threshold value without overflow between successive reset events. The activation counter may be implemented within the command monitoring logic of the control circuitry 302, positioned so that the counter is incremented on each qualifying activation command before the threshold comparison is evaluated.

The activation counter maintained by the control circuitry 302 in the counter-based criterion embodiment may include a counter incremented in response to activation commands directed to any memory bank of the plurality of memory banks 343A–343N. The counter may be a global counter, such that activation commands directed to bank-1343A, bank-2343B, bank-3343C, and bank-N 343N all contribute to incrementing the same counter, regardless of which bank is the target of each individual activation command. Furthermore, the activation counter may be incremented in response to activation commands irrespective of the rank or subchannel associated with the respective activation command. In a system where the memory controller 301 manages activation commands across multiple ranks and subchannels via the interface 310, all activation commands across all ranks and subchannels can increment the same global activation counter. In an example where the interface 310 supports two ranks each containing sixteen banks across two subchannels, the global activation counter is incremented for every activation command directed to any of the sixty-four addressable banks, without distinguishing among them for counter management purposes. In an alternative example, the control circuitry 302 may maintain a separate activation counter per rank, each counter being incremented only by activation commands directed to banks within the corresponding rank, with the sampling criterion applied independently per rank using the respective per-rank counter value.

In the counter-based criterion embodiment, the result may represent issuance of the refresh management command when the value of the activation counter reaches a threshold value. For example, when the activation counter value equals the threshold value, the control circuitry 302 produces a result indicating that a refresh management command should be issued directed to the memory bank identified by the activation command that caused the counter to reach the threshold. Upon the value of the activation counter reaching the threshold value, the control circuitry 302 resets the activation counter to zero, and the counter resumes incrementing from zero on the next detected activation command.

In an example, a threshold value of 200 may refer to that the control circuitry 302 issues one refresh management command for every 200 activation commands detected across all banks, ranks, and subchannels, with each issued command directed to whichever memory bank was targeted by the 200th activation command. The threshold comparison and reset may occur within the control circuitry 302 before the next activation command is processed.

The threshold value used in the counter-based criterion embodiment is configurable. For example, the threshold value may be set via a configuration register within the control circuitry 302, programmed at boot time by platform firmware such as a basic input/output system, or adjusted at runtime through a memory controller configuration interface. Decreasing the threshold value increases the frequency of refresh management command issuance relative to the activation command rate, increasing the rate of proactive mitigation at the cost of additional command bus occupancy and power consumption. Increasing the threshold value decreases the frequency of refresh management command issuance, reducing command bus occupancy at the cost of lower proactive mitigation rate. In an example, the configurable threshold value is stored in a mode register of the memory controller 301 that is accessible to platform firmware, enabling the threshold to be adjusted at system initialization based on the identity and characteristics of the memory device 304 detected during memory training. In an example, the threshold value may also be adjusted during runtime operation based on the observed frequency of alert signal assertions received by the control circuitry 302 via the interface 310, such that if the frequency of alert signal assertions exceeds a target rate, the threshold value may be decreased to increase the rate of refresh management command issuance and/or if alert signal assertions occur at a negligible rate, the threshold value may be increased to reduce command bus occupancy.

In 404, the decision point at which the result produced at 403 governs the subsequent action of the control circuitry 302 is represented. If the result indicates that no refresh management command should be issued, i.e., the NO branch of 404, the control circuitry 302 does not issue a refresh management command for the currently detected activation command and returns to 402 to monitor for the next qualifying activation command. If the result indicates that a refresh management command should be issued, i.e., the YES branch of 404, the control circuitry 302 proceeds to issue the refresh management command directed to the memory bank identified at 402 via the interface 310. The refresh management command specifies the memory bank address identifying the detected memory bank, preferably without specifying a memory row address. In the counter-based criterion embodiment, the control circuitry 302 also resets the activation counter upon taking the YES branch, prior to returning to 402.

In 405, the response of the memory device 304 to the refresh management command issued by the control circuitry 302 is represented. Upon receiving the refresh management command via the interface 310, the memory device control circuitry 350 may be configured to use the per-row activation counts maintained internally for the memory bank specified in the command to select at least one memory row within that bank.

The memory device control circuitry 350 may select the memory row or rows with the highest accumulated per-row activation counts within the specified bank, identifying those rows as the most likely aggressor rows at the time the refresh management command is received. The memory device control circuitry 350 then performs a refresh operation on one or more memory rows adjacent to the selected memory row or rows within the memory circuit 342, restoring the charge in the potential victim rows. The memory device 304 may perform this mitigation for one or more banks, depending on whether a per-bank or subset-targeting refresh management command was issued.

It is to be noted that the flow of FIG. 4 may be a continuous loop. After completing step 405 or after taking the NO branch at 404, the control circuitry 302 returns to 402 and monitors for the next qualifying activation command. Every activation command detected by the control circuitry 302 is individually subjected to the sampling criterion at 403. Over time, the cumulative effect of this per-command application is that memory banks receiving activation commands at a higher rate are subjected to the sampling criterion more frequently and therefore receive refresh management commands at a correspondingly higher rate. A memory bank receiving no activation commands is never the target of a refresh management command issued via the sampling-based flow.

In the probabilistic criterion embodiment, the control circuitry 302 may generate a pseudo-random event in response to each detected activation command by producing a pseudo-random value using a linear feedback shift register. A linear feedback shift register may refer to a shift register whose input bit is a linear function, typically an exclusive-OR, of a subset of the register's previous state bits, selected according to a feedback polynomial. The feedback polynomial determines the period of the pseudo-random sequence, which may correspond to the number of distinct values the register produces before repeating. In an example, the control circuitry 302 implements a 16-bit linear feedback shift register with a maximal-length feedback polynomial, producing a sequence of 65,535 distinct pseudo-random values before the sequence repeats. The linear feedback shift register may be clocked once on each detected activation command, producing one new pseudo-random value per activation command. The linear feedback shift register may be seeded at system initialization with a non-zero value derived from a hardware entropy source, a platform-specific identifier, or a fixed configuration value, in order to establish the initial state of the pseudo-random sequence.

The pseudo-random value produced by the linear feedback shift register on each detected activation command may be compared against a probability threshold value stored in a configuration register of the control circuitry 302. For example, if the pseudo-random value is less than the probability threshold, the result at step 403 indicates issuance of a refresh management command for the memory bank identified at step 402. If the pseudo-random value is greater than or equal to the probability threshold, the result indicates no issuance. The probability threshold value thus defines the fraction of detected activation commands that, on average, will result in refresh management command issuance.

In an example, a probability threshold corresponding to a selection probability of 1/200 may correspond to that the control circuitry 302 issues a refresh management command for approximately one in every 200 detected activation commands, averaged across a sufficiently long sequence. The relationship between the probability threshold register value and the intended selection probability may be determined by the bit width of the linear feedback shift register output. Illustratively, for a 16-bit register, a threshold register value of 328 corresponds to a selection probability of approximately 1/200, since 65535/200 ≈ 328.

The probabilistic criterion embodiment may result in refresh management command issuance that is non-deterministic with respect to the timing of the activation commands. In the counter-based criterion embodiment, the activation counter increments by one on each detected activation command, and the result indicates issuance deterministically when the counter reaches the threshold value. An entity observing the activation command stream directed to a specific memory bank could, in principle, determine from the global counter state when the threshold will next be reached.

In the probabilistic criterion embodiment, the result for each activation command is determined by a pseudo-random value that is not predictable without knowledge of the internal state of the linear feedback shift register. Because the linear feedback shift register state is internal to the control circuitry 302 and not observable via the interface 310, an external entity cannot predict whether any given activation command will result in refresh management command issuance.

The non-deterministic issuance property of the probabilistic criterion embodiment applies specifically to the relationship between activation command timing and refresh management command issuance timing. Even in the counter-based criterion embodiment, the global scope of the activation counter, which is incremented by activation commands directed to any memory bank, any rank, and any subchannel, makes the counter state difficult to predict from the perspective of an entity targeting a single memory bank, because the counter advances in response to activation commands to all other banks in the system. However, in a system with low memory traffic or in a scenario where a single bank accounts for the majority of activations, the counter state may be more predictable. The probabilistic criterion embodiment can eliminate this residual predictability by replacing the deterministic threshold comparison with a pseudo-random evaluation, ensuring that the timing of refresh management command issuance remains non-deterministic regardless of the activation command pattern or the distribution of activations across banks.

Because the sampling criterion is applied at the point of each individual activation command detected at 402, the refresh management commands issued by the control circuitry 302 are directed to specific memory banks in proportion to the rate at which those banks receive activation commands. A memory bank that receives activation commands at twice the rate of another bank will, on average over a sufficiently long period, be the target of refresh management commands at twice the rate. A memory bank that receives no activation commands during a given period will not be the target of any refresh management commands issued by the sampling-based flow during that period. This proportional relationship arises directly from the per-command application of the sampling criterion.

The control circuitry 302 determines the result at 403 independently of individual activation counts maintained per memory bank of the plurality of memory banks 343A–343N. In the probabilistic criterion embodiment, the pseudo-random event can be generated without reference to the activation history of any specific memory bank. The linear feedback shift register may be clocked once per detected activation command regardless of which bank the command targets. In the counter-based criterion embodiment, the global activation counter is incremented once per detected activation command regardless of the target bank, and the threshold comparison is applied to this single global counter value rather than to a per-bank counter value.

In both embodiments, the control circuitry 302 requires no counter hardware allocated per memory bank. In a memory controller managing a large number of banks across multiple ranks and subchannels, for example, a system with four subchannels, two ranks per subchannel, and sixteen banks per rank, yielding 128 banks in total, the elimination of per-bank counter hardware represents a proportional reduction in the counter resources required within the control circuitry 302, since the sampling-based approach requires at most one global counter or one linear feedback shift register regardless of the total bank count.

In an example, the control circuitry 302 is further configured to receive an alert signal from the memory device 304 via the sideband signal path of the interface 310, wherein the alert signal indicates that an activation count for a memory row within a memory bank of the plurality of memory banks 343A–343N has reached a limit maintained internally by the memory device control circuitry 350. Upon receiving the alert signal, the control circuitry 302 issues a further refresh management command to the memory device 304 and stalls normal memory traffic for the duration required by the memory interface specification. The proactive refresh management commands issued by the sampling-based flow of FIG. 4 and the reactive refresh management commands issued in response to the alert signal are complementary mechanisms. The proactive commands reduce the frequency with which the memory device control circuitry 350 asserts the alert signal by providing mitigation before the internal per-row activation count reaches the alert limit, while the reactive response to the alert signal provides a fallback for cases where the sampling-based issuance rate is insufficient to prevent the internal count from reaching the limit. The alert signal path of the interface 310 can remain active alongside the proactive sampling-based mechanism.

In the counter-based criterion embodiment, the sampling parameter is the threshold value against which the activation counter is compared, such that decreasing the threshold value increases the frequency of refresh management command issuance, and increasing the threshold value decreases that frequency. In the probabilistic criterion embodiment, the sampling parameter is the probability threshold value against which the pseudo-random output of the linear feedback shift register is compared under a less-than criterion, such that increasing the probability threshold value increases the fraction of detected activation commands that produce a result indicating issuance, and decreasing the probability threshold value decreases that fraction. In both embodiments, the sampling parameter provides a configurable control over the rate of refresh management command issuance relative to the activation command rate, with the direction of adjustment differing between embodiments according to the structure of the respective sampling criterion.

The rate at which the memory device control circuitry 350 asserts the alert signal under a given workload depends on the relationship between the activation rate directed at individual memory rows and the Rowhammer threshold NRH of the memory device 304. When the sampling parameter is set such that the average interval between successive refresh management commands directed to a given memory bank is reduced relative to the interval at which per-row activation counts would otherwise reach the alert limit, the sampling-based proactive mechanism can suppress alert signal assertions substantially or entirely for memory devices with higher NRH values.

For example, in a memory device 304 with NRH equal to 512, configuring the sampling parameter to yield approximately one refresh management command per 200 detected activation commands across all banks can eliminate alert signal assertions across representative memory-intensive workloads, because the proactive refresh management commands reduce per-row activation counts within each bank before any row reaches the alert limit. For memory devices 304 with lower NRH values, such as NRH equal to 256 or NRH equal to 128, the same sampling parameter setting reduces alert signal assertion rates relative to a configuration with no proactive refresh management commands, but may not eliminate them entirely, because the lower threshold requires a more aggressive sampling parameter to achieve full suppression. In such cases, the sampling parameter may be decreased to increase the proactive refresh management command rate, at the cost of additional command bus occupancy, as described with reference to the configurable sampling parameter adjustment in the preceding paragraphs. The alert signal mechanism remains available as a complementary reactive fallback regardless of the sampling parameter value selected.

The sampling-based approach described herein may result in a higher total number of refresh management commands issued relative to an approach that issues refresh management commands only in response to the assertion of the alert signal by the memory device 304. For example, when the sampling parameter is configured to yield one refresh management command per 200 detected activation commands, the total refresh management command rate is determined by the aggregate activation command rate across all memory banks, ranks, and subchannels accessible via the interface 310.

A periodic approach that issues one refresh management command per bank at a fixed average interval exposes a predictable mitigation schedule: an attacker who can measure or infer either the average or the maximum interval can construct an activation pattern that concentrates activations in the period immediately following each mitigation event, exploiting the full interval before the next command is issued. Furthermore, a periodic approach issues refresh management commands to all memory banks at the same fixed rate regardless of each bank's activation history, expending mitigation resources on banks that present no Rowhammer threat while providing no additional mitigation for banks that are under active attack. The sampling-based approach described herein has no fixed issuance interval: refresh management commands are issued in response to detected activation commands rather than according to a timer, so no periodic mitigation schedule exists for an attacker to observe or exploit, and mitigation effort is automatically concentrated on the memory banks receiving the highest activation rates.

It is to be noted that a class of Rowhammer attacks generally involves a deliberate pattern of repeated activation commands directed by an attacker-controlled process to one or more aggressor rows, with the objective of inducing bit flips in adjacent victim rows. A sophisticated variant of this attack attempts to exploit knowledge of the memory controller's mitigation schedule by concentrating activation commands within time intervals during which the memory controller is unlikely to issue a refresh management command.

A memory controller that issues refresh management commands at fixed periodic intervals may provide the attacker with a predictable mitigation schedule. If the control circuitry issues one refresh management command per bank at a fixed interval, for example, every x microseconds, an attacker who can measure or infer the interval can construct an activation pattern that concentrates activations in the period immediately following each mitigation event, exploiting the full interval before the next command is issued. Similarly, a control circuitry that issues refresh management commands based on a per-bank activation counter with a fixed threshold issues the command deterministically when the counter for a given bank reaches the threshold value.

In the apparatus as described herein, the issuance of the refresh management command is non-deterministic with respect to the timing of the activation commands when the control circuitry 302 applies the probabilistic criterion as the sampling criterion. For each detected activation command at 402 of FIG. 4, the result at 403 is determined by a pseudo-random event whose outcome is not predictable without knowledge of the internal state of the linear feedback shift register within the control circuitry 302. The internal state of the linear feedback shift register is not observable via the interface 310 and is not inferable from the sequence of activation commands issued to the memory device 304 or from the sequence of refresh management commands observed on the command and address bus.

Consequently, an attacker directing activation commands to a memory bank cannot determine whether any particular activation command will result in a refresh management command being issued for that bank, and cannot construct an activation pattern that reliably avoids triggering the sampling criterion. In the counter-based criterion embodiment, the global scope of the activation counter, i.e., incremented by activation commands directed to any memory bank, rank, or subchannel, introduces a degree of unpredictability for an attacker targeting a single bank, because the counter advances in response to activity across the entire memory system that the attacker does not control.

Because the control circuitry 302 applies the sampling criterion at the point of each individual activation command detected at 402 of FIG. 4, the rate at which the control circuitry 302 issues refresh management commands directed to a given memory bank is proportional to the rate at which that bank receives activation commands. A memory bank that is targeted by an attacker at a high activation rate, which corresponds to the condition that creates a Rowhammer threat, will receive refresh management commands from the control circuitry 302 at a correspondingly high rate, without requiring the control circuitry 302 to explicitly detect or respond to an elevated activation rate. The mitigation effort therefore concentrates on the memory bank or banks that are under active attack, as a direct consequence of the per-command sampling structure. A memory bank that receives no activation commands during a given period receives no refresh management commands from the sampling-based flow during that period, so mitigation resources are not expended on banks that present no Rowhammer threat.

In an example, the control circuitry 302 is configured to adjust a sampling parameter of the sampling criterion, wherein the sampling parameter controls the rate of issuance of the refresh management command relative to the number of detected activation commands. The sampling parameter may correspond to an abstraction that applies across both embodiments of the sampling criterion described with reference to FIG. 4.

In the counter-based criterion embodiment, the sampling parameter is the threshold value against which the activation counter is compared, involving adjusting the threshold value changes the number of activation commands required, on average, to trigger one refresh management command issuance. In the probabilistic criterion embodiment, the sampling parameter is the probability threshold value against which the pseudo-random output of the linear feedback shift register is compared. Adjusting the probability threshold changes the fraction of detected activation commands that, on average, produce a result indicating issuance. In both embodiments, a reduction in the sampling parameter value increases the average rate of refresh management command issuance relative to the activation command rate, and an increase in the sampling parameter value decreases that rate. The sampling parameter can therefore provide a unified configurable control over the aggressiveness of the proactive mitigation performed by the control circuitry 302.

In an example, the sampling parameter is adjustable based on a reliability characteristic of the memory device 304. For example, the Rowhammer threshold of a DRAM device, which corresponds to the number of activations to an aggressor row within a refresh interval after which bit flips in adjacent victim rows become probable, is not a fixed property of the memory device 304 over its operational lifetime. As the memory device 304 ages, charge retention characteristics of individual memory cells may degrade, reducing the number of activations required to induce bit flips in adjacent rows and thereby reducing the effective Rowhammer threshold. Operating conditions including elevated temperature and reduced supply voltage may similarly reduce the effective Rowhammer threshold of the memory device 304 at a given point in time.

In an example, when the reliability characteristic of the memory device 304 indicates that the Rowhammer threshold has decreased, which may be either due to device aging or due to adverse operating conditions, the system (e.g., the control circuitry 302) can respond by decreasing the sampling parameter value, thereby increasing the rate of refresh management command issuance and providing more frequent proactive mitigation. In an example, the memory device 304 provides a reliability indicator through a device-readable register accessible via the interface 310 that reflects the current effective Rowhammer threshold, and the control circuitry 302 reads this indicator and adjusts the sampling parameter accordingly.

The sampling parameter may be set at system initialization time or adjusted during runtime operation of the computing system 100. At initialization time, platform firmware such as a basic input/output system may read device identification information from the memory device 304 via the interface 310, determine the appropriate sampling parameter value for the identified device and configuration, and program the sampling parameter into a configuration register of the control circuitry 302. This boot-time configuration allows a single memory controller design to serve different memory device types, for example, memory devices 304 conforming to different DRAM specifications or from different manufacturers with different Rowhammer threshold characteristics, without hardware changes to the control circuitry 302. During runtime operation, the sampling parameter may be adjusted by a memory management agent executing on the processor 102, by a firmware routine responding to a change in operating conditions such as a temperature threshold crossing, or by a periodic reliability assessment procedure that monitors error correction counts and adjusts the sampling parameter in response to observed trends. In an example, the control circuitry 302 exposes the sampling parameter as a memory-mapped configuration register accessible to the operating system or firmware, enabling runtime adjustment without requiring a system restart.

The sampling criterion, including the choice between the probabilistic criterion and the counter-based criterion, the scope of the activation counter in the counter-based embodiment, and the specific sampling parameter value, may be configured independently per memory channel or per instance of the memory controller 301 within the computing system 100. In a system that includes multiple memory channels, each channel may connect to memory devices 304 with different Rowhammer threshold characteristics, for example, memory devices from different manufacturers or conforming to different specifications, and the sampling parameter for each channel may be set independently to reflect the reliability characteristics of the memory device 304 on that channel. In an example, a computing system with four memory channels may configure two channels connecting to memory devices 304 with a lower Rowhammer threshold to use a lower sampling parameter value, while the remaining two channels connecting to memory devices 304 with a higher Rowhammer threshold use a higher sampling parameter value, resulting in different refresh management command rates per channel without modifying the control circuitry 302 hardware.

In an example, the memory device 304 includes a dynamic random-access memory device configured to support per-row activation counting. The apparatus and methods described herein are applicable to any memory device that supports per-row activation counting and that accepts refresh management commands specifying a memory bank address, as the control circuitry 302 issues standard refresh management commands and delegates row address selection entirely to the memory device control circuitry 350.

The sampling-based refresh management operation described herein may operate alongside and complements the memory device control circuitry 350's own per-row activation counting and alert signal mechanisms. The proactive refresh management commands issued by the control circuitry 302 through the sampling-based flow of FIG. 4 can reduce the frequency with which the internal per-row activation counts within the memory device 304 reach the alert limit, thereby reducing the frequency with which the memory device control circuitry 350 asserts the alert signal. The alert signal mechanism may remain available as a reactive fallback, such that the control circuitry 302 can continue to monitor the alert signal path of the interface 310 and issue a further refresh management command in response to any alert signal assertion that occurs despite the proactive sampling-based issuance.

The apparatus described herein may be implemented as part of a memory controller within a processor, a system-on-chip, or a standalone memory controller integrated circuit. The control circuitry 302 may be implemented in dedicated hardware logic, a programmable logic device, a finite state machine, or a combination of such implementations within the memory controller 301. The interface 310 may conform to any DRAM specification that supports per-row activation counting and refresh management commands, including those identified above.

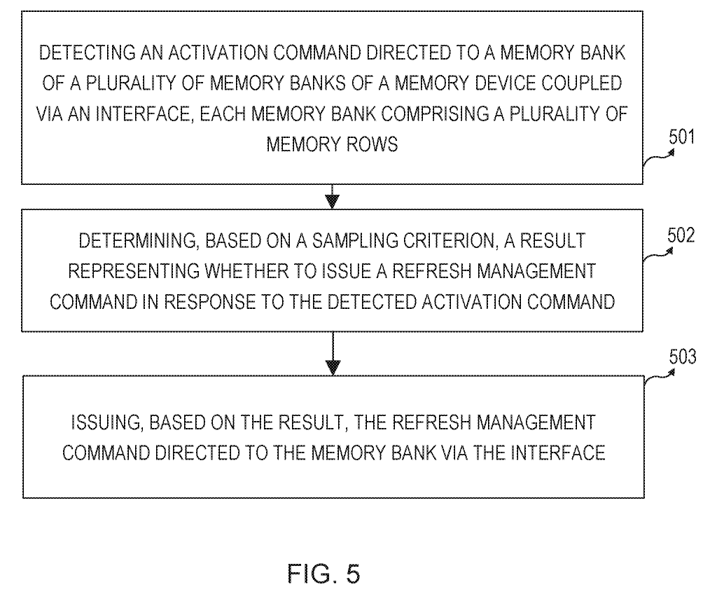

FIG. 5 shows an example of a method. The method may include: detecting 501 an activation command directed to a memory bank of a plurality of memory banks of a memory device coupled via an interface, each memory bank including a plurality of memory rows; determining 502, based on a sampling criterion, a result representing whether to issue a refresh management command in response to the detected activation command; and issuing 503, based on the result, the refresh management command directed to the memory bank via the interface. A non-transitory computer-readable medium may include instructions which, if executed by a processor, cause the processor to perform the method.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more."

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 may include the subject matter of an apparatus, including: an interface coupled to a memory device including a plurality of memory banks, each memory bank including a plurality of memory rows; and control circuitry coupled to the interface, wherein the control circuitry is configured to: detect an activation command directed to a memory bank of the plurality of memory banks; determine, based on a sampling criterion, a result representing whether to issue a refresh management command in response to the detected activation command; and issue, based on the result, the refresh management command directed to the memory bank via the interface.

Example 2 may include the subject matter of example 1, wherein the control circuitry is configured to apply a probabilistic criterion as the sampling criterion.

Example 3 may include the subject matter of example 2, wherein the probabilistic criterion is based on a random or pseudo-random event generated in response to the detected activation command.

Example 4 may include the subject matter of example 1, wherein the sampling criterion is based on an activation counter, wherein the activation counter indicates a counted number of received activation commands.

Example 5 may include the subject matter of example 4, wherein the activation counter includes a counter incremented in response to activation commands directed to any memory bank of the plurality of memory banks.

Example 6 may include the subject matter of any one of examples 4 to 5, wherein the activation counter is incremented in response to activation commands irrespective of a rank or a subchannel associated with the respective activation command.

Example 7 may include the subject matter of any one of examples 4 to 6, wherein the result represents issuance of the refresh management command when a value of the activation counter reaches a threshold value, and wherein the control circuitry is configured to reset the activation counter upon the value reaching the threshold value.

Example 8 may include the subject matter of example 7, wherein the threshold value is configurable.

Example 9 may include the subject matter of any one of examples 1 to 8, wherein the refresh management command specifies a memory bank address identifying the memory bank without specifying a memory row address.

Example 10 may include the subject matter of any one of examples 1 to 9, may further include the memory device, wherein the memory device is configured to, in response to the refresh management command, internally select at least one memory row within the memory bank based on per-row activation counts maintained by the memory device.

Example 11 may include the subject matter of example 10, wherein the memory device is configured to perform a refresh operation on one or more memory rows adjacent to the at least one internally selected memory row.

Example 12 may include the subject matter of any one of examples 1 to 11, wherein the activation command includes at least one of a command causing an internal activate operation or a command causing a precharge operation in the memory bank.

Example 13 may include the subject matter of any one of examples 1 to 12, wherein the refresh management command is a per-bank refresh management command targeting the memory bank.

Example 14 may include the subject matter of any one of examples 1 to 13, wherein the control circuitry is configured to determine the result independently of individual activation counts maintained per memory bank of the plurality of memory banks.

Example 15 may include the subject matter of any one of examples 1 to 14, wherein a rate of issuance of the refresh management commands directed to the memory bank is proportional to a rate of the activation commands directed to the memory bank.

Example 16 may include the subject matter of any one of examples 1 to 15, wherein the control circuitry is further configured to receive an alert signal from the memory device, wherein the alert signal indicates that an activation count for a memory row within a memory bank of the plurality of memory banks has reached a limit, and to issue a further refresh management command in response to the alert signal.

Example 17 may include the subject matter of any one of examples 1 to 16, wherein issuance of the refresh management command is non-deterministic with respect to a timing of the activation commands.

Example 18 may include the subject matter of any one of examples 1 to 17, wherein the control circuitry is configured to adjust a sampling parameter of the sampling criterion, wherein the sampling parameter controls a rate of issuance of the refresh management command relative to a number of detected activation commands.

Example 19 may include the subject matter of example 18, wherein the sampling parameter is adjustable based on a reliability characteristic of the memory device.

Example 20 may include the subject matter of any one of examples 1 to 19, wherein the memory device includes a dynamic random-access memory device configured to support per-row activation counting.

Example 21 may include the subject matter of a method including: detecting an activation command directed to a memory bank of a plurality of memory banks of a memory device coupled via an interface, each memory bank including a plurality of memory rows; determining, based on a sampling criterion, a result representing whether to issue a refresh management command in response to the detected activation command; and issuing, based on the result, the refresh management command directed to the memory bank via the interface.

Example 22 may include the subject matter of example 21, may further include applying a probabilistic criterion as the sampling criterion.

Example 23 may include the subject matter of example 22, wherein the probabilistic criterion is based on a random or pseudo-random event generated in response to the detected activation command.

Example 24 may include the subject matter of example 21, wherein the sampling criterion is based on an activation counter, wherein the activation counter indicates a counted number of received activation commands.

Example 25 may include the subject matter of example 24, wherein the activation counter includes a counter incremented in response to activation commands directed to any memory bank of the plurality of memory banks.

Example 26 may include the subject matter of any one of examples 24 to 25, wherein the activation counter is incremented in response to activation commands irrespective of a rank or a subchannel associated with the respective activation command.

Example 27 may include the subject matter of any one of examples 24 to 26, wherein the result represents issuance of the refresh management command when a value of the activation counter reaches a threshold value, and may further include reset the activation counter upon the value reaching the threshold value.

Example 28 may include the subject matter of example 27, wherein the threshold value is configurable.

Example 29 may include the subject matter of any one of examples 21 to 28, wherein the refresh management command specifies a memory bank address identifying the memory bank without specifying a memory row address.

Example 30 may include the subject matter of any one of examples 21 to 29, may further include, in response to the refresh management command, internally selecting at least one memory row within the memory bank based on per-row activation counts maintained by the memory device.

Example 31 may include the subject matter of example 30, may further include performing a refresh operation on one or more memory rows adjacent to the at least one internally selected memory row.

Example 32 may include the subject matter of any one of examples 21 to 31, wherein the activation command includes at least one of a command causing an internal activate operation or a command causing a precharge operation in the memory bank.

Example 33 may include the subject matter of any one of examples 21 to 32, wherein the refresh management command is a per-bank refresh management command targeting the memory bank.

Example 34 may include the subject matter of any one of examples 21 to 33, may further include determining the result independently of individual activation counts maintained per memory bank of the plurality of memory banks.

Example 35 may include the subject matter of any one of examples 21 to 34, wherein a rate of issuance of the refresh management commands directed to the memory bank is proportional to a rate of the activation commands directed to the memory bank.

Example 36 may include the subject matter of any one of examples 21 to 35, may further include receiving an alert signal from the memory device, wherein the alert signal indicates that an activation count for a memory row within a memory bank of the plurality of memory banks has reached a limit, and to issue a further refresh management command in response to the alert signal.

Example 37 may include the subject matter of any one of examples 21 to 36, wherein issuance of the refresh management command is non-deterministic with respect to a timing of the activation commands.

Example 38 may include the subject matter of any one of examples 21 to 37, may further include adjusting a sampling parameter of the sampling criterion, wherein the sampling parameter controls a rate of issuance of the refresh management command relative to a number of detected activation commands.

Example 39 may include the subject matter of example 38, wherein the sampling parameter is adjustable based on a reliability characteristic of the memory device.

Example 40 may include the subject matter of any one of examples 21 to 39, wherein the memory device includes a dynamic random-access memory device configured to support per-row activation counting.

Example 41 may include a non-transitory computer-readable medium including one or more instructions which, if executed by a processor, cause the processor to perform the method of any one of examples 21 to 40.

What is claimed is:

1. An apparatus comprising:
an interface coupled to a memory device comprising a plurality of memory banks, each memory bank comprising a plurality of memory rows; and
control circuitry coupled to the interface, wherein the control circuitry is configured to:
detect an activation command directed to a memory bank of the plurality of memory banks;
determine, based on a sampling criterion, a result representing whether to issue a refresh management command in response to the detected activation command; and
issue, based on the result, the refresh management command directed to the memory bank via the interface.

2. The apparatus of claim 1, wherein the control circuitry is configured to apply a probabilistic criterion as the sampling criterion.

3. The apparatus of claim 2, wherein the probabilistic criterion is based on a random or pseudo-random event generated in response to the detected activation command.

4. The apparatus of claim 1, wherein the sampling criterion is based on an activation counter, wherein the activation counter indicates a counted number of received activation commands.

5. The apparatus of claim 4, wherein the activation counter comprises a counter incremented in response to activation commands directed to any memory bank of the plurality of memory banks.

6. The apparatus of claim 4 wherein the activation counter is incremented in response to activation commands irrespective of a rank or a subchannel associated with the respective activation command.

7. The apparatus of claim 4, wherein the result represents issuance of the refresh management command when a value of the activation counter reaches a threshold value, and wherein the control circuitry is configured to reset the activation counter upon the value reaching the threshold value.

8. The apparatus of claim 7, wherein the threshold value is configurable.

9. The apparatus of claim 1, wherein the refresh management command specifies a memory bank address identifying the memory bank without specifying a memory row address.

10. The apparatus of claim 1, further comprising the memory device, wherein the memory device is configured to, in response to the refresh management command, internally select at least one memory row within the memory bank based on per-row activation counts maintained by the memory device.

11. The apparatus of claim 10, wherein the memory device is configured to perform a refresh operation on one or more memory rows adjacent to the at least one internally selected memory row.

12. The apparatus of claim 1, wherein the activation command comprises at least one of a command causing an internal activate operation or a command causing a precharge operation in the memory bank.

13. The apparatus of claim 1, wherein the refresh management command is a per-bank refresh management command targeting the memory bank.

14. The apparatus of claim 1, wherein the control circuitry is configured to determine the result independently of individual activation counts maintained per memory bank of the plurality of memory banks.

15. The apparatus of claim 1, wherein a rate of issuance of the refresh management commands directed to the memory bank is proportional to a rate of the activation commands directed to the memory bank.

16. The apparatus of claim 1, wherein the control circuitry is further configured to receive an alert signal from the memory device, wherein the alert signal indicates that an activation count for a memory row within a memory bank of the plurality of memory banks has reached a limit, and to issue a further refresh management command in response to the alert signal.

17. The apparatus of claim 1, wherein the control circuitry is configured to adjust a sampling parameter of the sampling criterion, wherein the sampling parameter controls a rate of issuance of the refresh management command relative to a number of detected activation commands.

18. The apparatus of claim 17, wherein the sampling parameter is adjustable based on a reliability characteristic of the memory device.

19. A method comprising:
detecting an activation command directed to a memory bank of a plurality of memory banks of a memory device coupled via an interface, each memory bank comprising a plurality of memory rows;
determining, based on a sampling criterion, a result representing whether to issue a refresh management command in response to the detected activation command; and
issuing, based on the result, the refresh management command directed to the memory bank via the interface.

20. The method of claim 19, further comprising applying a probabilistic criterion as the sampling criterion.
